(19) United States
(12) Patent Application Publication
(10) Pub. No.: US 2010/0090782 A1
(43) Pub. Date: Apr. 15, 2010

(54) STRIP LINE FILTER

(76) Inventor: Soichi Nakamura, Omihachiman-shi (JP)

Correspondence Address: DICKSTEIN SHAPIRO LLP, 1633 Broadway, NEW YORK, NY, 10019, US

(21) Appl. No.: 12/573,621

(22) Filed: Oct. 5, 2009

(30) Foreign Application Priority Data
Oct. 15, 2008 (JP) 2008-265944

(51) Int. Cl. H01P 1/203

(52) U.S. Cl. 333/204

(57) ABSTRACT

A strip line filter includes a dielectric substrate having a ground electrode, input/output electrodes, upper-surface lines, and side-surface lines. Certain side-surface lines are connected to the ground electrode at first terminal portions thereof which are positioned near the a bottom surface of the dielectric substrate, and are connected to certain upper-surface lines among the upper-surface lines at second terminal portions thereof which are positioned near a top surface. The second terminal portions of the side-surface lines are deviated from the first terminal portions of the side-surface lines in a direction parallel to the top and bottom surfaces of the dielectric substrate.

### BACKGROUND OF THE INVENTION

1. Field of the Invention

The present invention relates to a strip line filter including a dielectric substrate and strip lines arranged on the dielectric substrate.

2. Description of the Related Art

Microstrip line filters including strip-line resonators arranged on dielectric substrates have been used in various fields (refer to Japanese Patent 3018214).

An example of a configuration of a conventional microstrip line filter 100 will be described hereinafter. FIG. 1A is a bottom view illustrating a conventional microstrip line filter according to Japanese Patent 3018214. FIG. 1B is a perspective top view illustrating the microstrip line filter 100.

The microstrip line filter 100 includes a dielectric substrate 101 and another dielectric substrate (not shown) laminated on the dielectric substrate 101. On a bottom surface 101A of the dielectric substrate 101, a ground electrode 104A and input/output electrodes 102A, 102B, 103A, and 103B are arranged. On a top surface 101B of the dielectric substrate 101, top-surface lines 106A to 106C and projecting electrodes 105A and 105B are arranged. On a side surface 101C of the dielectric substrate 101, a side-surface ground electrode 104B is arranged. On a side surface 101D of the dielectric substrate 101, a side-surface line 107 is arranged.

When an electrode pattern on a top surface is to be formed with high accuracy, a photolithography process, for example, may be used. In this case, however, in terms of production cost, a low-accuracy coating process is generally used for formation of electrode patterns on side surfaces and a bottom surface.

Although size reduction of electrode patterns has been required for size reduction of a chip in recent years, since accuracy of electrode patterns on side surfaces and a bottom surface is low, it is difficult to reduce widths of gaps between input/output electrodes and a ground electrode and to reduce sizes of the input/output electrodes. Accordingly, arrangement of the electrode patterns on the side surfaces and the bottom surface is strictly restricted. Therefore, arrangement of the electrode pattern on the top surface is also restricted, and consequently, it may be difficult to attain required filter characteristics.

### SUMMARY OF THE INVENTION

Accordingly, it is an object of the present invention to provide a small strip line filter which attains required filter characteristics while satisfying restriction of arrangement of an electrode pattern on a bottom surface of a dielectric substrate.

According to preferred embodiments of the present invention, the strip line filter includes a ground electrode, input/output electrode, top-surface lines, and side-surface lines. The ground electrode is arranged on the bottom surface of the dielectric substrate having a substantially rectangular plate-like shape. The input/output electrodes are arranged on the bottom surface so as to be separated from the ground electrode. The top-surface lines are arranged on a top surface of the dielectric substrate. The side-surface lines are arranged on side surfaces of the dielectric substrate, are connected to one of the ground electrode and the input/output electrodes at terminal portions thereof which are positioned near the bottom surface and which are connected to the bottom surface, and are connected to the top-surface lines at terminal portions thereof which are positioned near the top surface and which are connected to the top surface. The terminal portions of the side-surface lines near the top surface of the substrate are deviated from the corresponding terminal portions of the side-surface lines near the bottom surface of the substrate in the corresponding side surfaces in a direction parallel to the top and bottom surfaces.

With this configuration, since the terminal portions of the side-surface lines near the top surface are deviated from the corresponding terminal portions of the side-surface lines near the bottom surface, a degree of freedom of arrangement of the top-surface lines connected to the side-surface lines is enhanced. Accordingly, gap widths between the input/output electrodes and the ground electrode and sizes of the input/output electrodes are ensured while the top-surface lines are arranged so as to attain required filter characteristics.

The strip line filter may include sub-side-surface lines and electrode patterns of the side surfaces including the side surface lines and the sub-side-surface lines may be formed so as to be symmetric about the center point of the corresponding side surfaces. The sub-side-surface lines are arranged on certain side surfaces among the side surfaces so as to intersect with corresponding side-surface lines among the side-surface lines, and each of the sub-side-surface lines has one terminal portion, near the top surface, which is connected to the top surface and which is separated from the top-surface lines. Since the sub-side-surface lines are provided, the electrode patterns of the side surfaces including the side surface lines and the sub-side-surface lines can be formed so as to be symmetric about the center point of the corresponding side surfaces. Accordingly, although the terminal portions near the top surface and the corresponding terminal portions near the bottom surface are deviated from each other, electrode-patterning processing can be performed on the side surfaces without distinguishing between the top and bottom surfaces of the dielectric substrate.

Main line directions of the side-surface lines may be inclined relative to a direction perpendicular to the top and bottom surfaces of the dielectric substrate in the corresponding side surfaces. If the side-surface line has an angled portion or a corner, current constriction is generated at the portion and causes conductor loss. However, since the side-surface lines are inclined, an angled portion or a corner is not formed on the side-surface lines, and accordingly, conductor loss is suppressed and a filter having an excellent Q value can be realized.

Terminal portions of the side-surface lines near the bottom surface may be connected to the ground electrode. With this configuration, since the terminal portions near the bottom surface and the corresponding terminal portions near the top surface are deviated from each other, the resonators long than conventional resonators are realized, resulting in low resonant frequencies. In other words, the same resonant frequency is attained by a small filter. Moreover, filter characteristics can be controlled by changing a degree of the inclination of the side-surface lines.

Pairs of side surfaces, among the side surfaces, facing each other may have the same electrode patterns. By this, when the side-surface lines are to be formed, the pairs of side surfaces facing to each other in the dielectric substrate are not required to be distinguished from each other.

According to the preferred embodiments of the present invention, since the terminal portions of the side-surface lines near the top surface and the corresponding terminal portions of the side-surface lines near the bottom surface are deviated from each other, a degree of freedom of arrangement of the top-surface lines connected to the side-surface lines is enhanced. Accordingly, gap widths between the input/output electrodes and the ground electrode and sizes of the input/output electrodes are ensured while the top-surface lines are arranged so as to attain required filter characteristics. Consequently, a small filter having the required filter characteristic is realized while restriction of arrangement of an electrode pattern on a bottom surface of a dielectric substrate is satisfied.

Other features, elements, characteristics and advantages of the present invention will become more apparent from the following detailed description of preferred embodiments of the present invention with reference to the attached drawings.

### BRIEF DESCRIPTION OF THE DRAWINGS

FIGS. 1A and 1B are diagrams illustrating an example of a configuration of a conventional strip line filter;

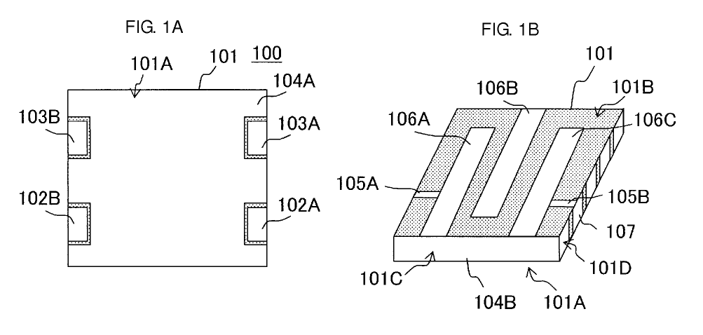

FIG. 2 is a development view illustrating a strip line filter according to a first embodiment;

FIG. 3 is an exploded perspective view illustrating the strip line filter shown in FIG. 2;

FIG. 4 is a development view illustrating a strip line filter according to a second embodiment;

FIG. 5 is a development view illustrating a strip line filter according to a third embodiment;

FIG. 6 is a development view illustrating a strip line filter according to a fourth embodiment; and

FIG. 7 is a development view illustrating a strip line filter according to a fifth embodiment.

### DESCRIPTION OF THE PREFERRED EMBODIMENTS

A strip line filter 1 according to a first embodiment of the present invention will now be described.

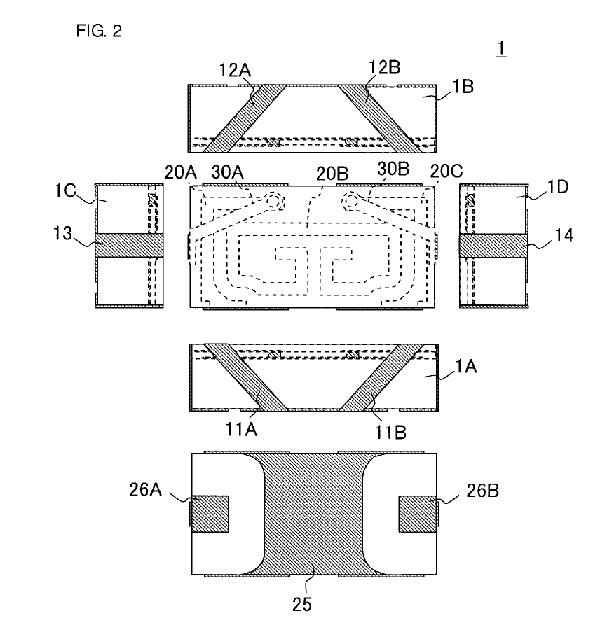

The strip line filter 1 of this embodiment is a band pass filter for high bands of UWB (Ultra Wide Band) communication. FIG. 2 is a development view illustrating the strip line filter 1 of this embodiment.

The strip line filter 1 includes side-surface lines 11A and 11B on a front surface 1A thereof. On a back surface 1B of the strip line filter 1, side-surface lines 12A and 12B are arranged. On a left surface 1C, a side-surface line 13 is arranged. On a right surface 1D, a side-surface line 14 is arranged. On a bottom surface serving as an implementing surface, a ground electrode 25 and input/output electrodes 26A and 26B are arranged. The ground electrode 25 and the input/output electrodes 26A and 26B are arranged separately from each other. When the strip line filter 1 is implemented on an implementing substrate, high-frequency-signal input/output terminals are connected to the input/output electrodes 26A and 26B, and a ground electrode of the implementing substrate is connected to the ground electrode 25 serving as a ground surface of resonators. Each of the ground electrode 25, the input/output electrodes 26A and 26B, and the side-surface lines 11A, 11B, 12A, 12B, 13, and 14 is formed of a silver electrode having a thickness of approximately 12 μm, and formed by applying nonphotosensitive silver paste using screen masking or metal masking and performing sintering.

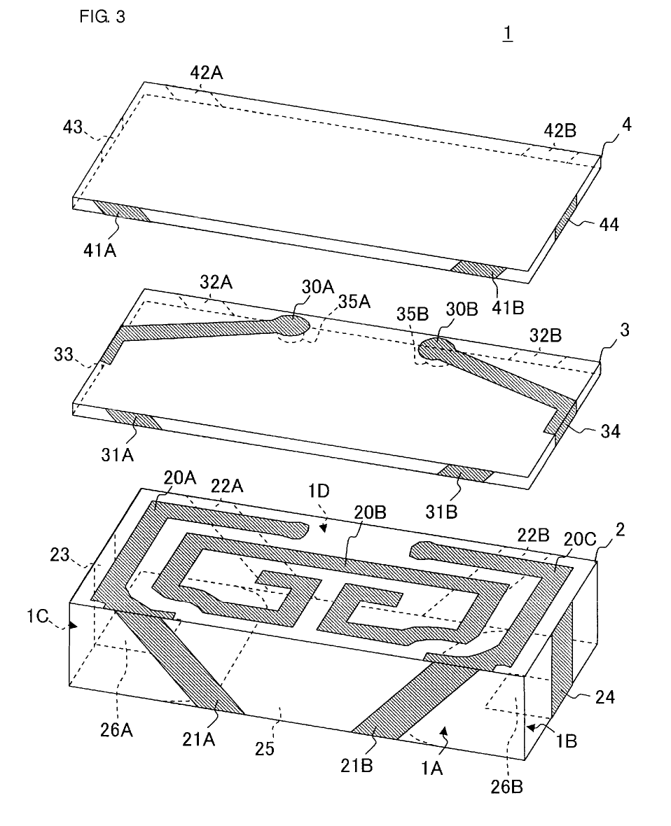

FIG. 3 is an exploded perspective view illustrating the strip line filter 1.

The strip line filter 1 includes a dielectric substrate 2, and first and second glass layers 3 and 4 which are laminated in this order from the bottom surface.

The dielectric substrate 2 is a sintered ceramic substrate which has a substantially rectangular plate-like shape, which has a relative permittivity of approximately 111, and which is formed of titanium oxide, for example. The dielectric substrate 2 includes, on a top surface, top-surface lines 20A to 20C included in resonators in three stages. Each of the top-surface lines 20A to 20C is a silver electrode having a thickness of approximately 4 μm, and formed by applying photosensitive silver paste on the dielectric substrate 2 and performing patterning by a photolithography process and performing sintering. Since the photosensitive silver electrodes are employed, the strip line filter 1 which has the electrodes formed with high accuracy and which is usable for the UWB communication is obtained. Furthermore, since the thicknesses of the electrodes on the side surfaces and the bottom surface are larger than those of the electrodes of the top-surface lines 20A to 20C, current at portions of the resonators near a ground terminal where current constriction is generally generated is dispersed, and conductor loss is reduced.

On a bottom surface of the dielectric substrate 2, the ground electrode 25 and the input/output electrodes 26A and 26B are arranged. On a front surface of the dielectric substrate 2, side-surface lines 21A and 21B included in the side-surface lines 11A and 11B, respectively, are arranged. The side-surface lines 21A and 21B are connected to the top-surface lines 20A and 20C, respectively, at terminal portions near the top surface, and connected to the ground electrode 25 at terminal portions near the bottom surface. On a back surface, side-surface lines 22A and 22B included in the side-surface lines 12A and 12B, respectively, are arranged. The side-surface lines 22A and 22B are connected to the ground electrode 25 at terminal portions near the bottom surface. On a left surface, a side-surface line 23 included in the side-surface line 13 is arranged. The side-surface line 23 is connected to the input/output electrode 26A at a terminal portion near the bottom surface. On a right surface, a side-surface line 24 included in the side-surface line 14 is arranged. The side-surface line 24 is connected to the input/output electrode 26B at a terminal portion near the bottom surface.

The first glass layer 3 has a thickness of approximately 20 μm, and is laminated on the top surface of the dielectric substrate 2. On a top surface of the first glass layer 3, external connection lines 30A and 30B are arranged. On a front surface, side-surface lines 31A and 31B included in the side-surface lines 11A and 11B, respectively, are arranged. On a back surface, side-surface lines 32A and 32B included in the side-surface lines 12A and 12B, respectively, are arranged. On a left surface, a side-surface line 33 included in the side-surface line 13 is arranged. The side-surface line 33 is connected to the external connection line 30A at a terminal portion near the top surface. On a right surface, a side-surface line 34 included in the side-surface line 14 is arranged. The side-surface line 34 is connected to the external connection line 30B at a terminal portion near the top surface.

The second glass layer 4 of a thickness of approximately 20 μm has a light-shielding characteristic and is laminated on the top surface of the first glass layer 3. On a front surface of the second glass layer 4, side-surface lines 41A and 41B included in the side-surface lines 11A and 11B, respectively, are arranged. On a back surface, side-surface lines 42A and 42B included in the side-surface lines 12A and 12B, respectively, are arranged. On a left surface, a side-surface line 43 included in the side-surface line 13 is arranged. On a right side, a side-surface line 44 included in the side-surface line 14 is arranged.

By laminating the first and second glass layers 3 and 4 on the dielectric substrate 2, mechanical protection and environmental resistance of an electrode pattern on the top surface of the dielectric substrate 2 and an electrode pattern on the top surface of the first glass layer 3 are ensured.

The top-surface line 20A arranged on the top surface of the dielectric substrate 2 extends along the left surface and the back surface starting from a connection portion between the top-surface line 20A and the side-surface line 21A, and has a substantially L-shape. The top-surface line 20B has a substantially C-shape with a front-side portion thereof open. The top-surface line 20C extends along the right surface and the back surface starting from a connection point between the top-surface line 20C and the side-surface line 21B, and has a substantially L-shape.

The external connection line 30A arranged on the top surface of the first glass layer 3 extends from a connection point between the external connection line 30A and the side-surface line 33 to a portion facing an open end of the top-surface line 20A, and is connected to the top-surface line 20A through a via hole 35A arranged in the first glass layer 3.

The external connection line 30B extends from a connection point between the external connection line 30B and the side-surface line 34 to a portion facing an open end of the top-surface line 20C, and is connected to the top-surface line 20C through a via hole 35B arranged in the first glass layer 3.

Accordingly, the side-surface line 21A and the top-surface line 20A are included in a ¼ wavelength resonant line of an input stage (output stage). Furthermore, the side-surface line 21B and the top-surface line 20C are included in a ¼ wavelength resonant line of an output stage (input stage). The resonant line of the input stage and the resonant line of the output stage are connected to a ½ wavelength resonant line in a middle stage including the top-surface line 20B to thereby constitute a filter having resonators in three stages. External connection between the resonant line including the top-surface line 20A and the input/output electrode 26A is realized by tap connection through the external connection line 30A, and external connection between the resonant line including the top-surface line 20C and the input/output electrode 26B is realized by tap connection through the external connection line 30B.

The side-surface lines 11A and 11B form a smaller gap therebetween at terminal portions thereof near the bottom surface and a larger gap therebetween at terminal portions near the top surface. Therefore, the terminal portion near the bottom surface and the terminal portion near the top surface of the side-surface line 11A are deviated from each other and the terminal portion near the bottom surface and the terminal portion near the top surface of the side-surface line 11B are deviated from each other in the front surface 1A in a direction in parallel to the top and bottom surfaces of the substrate 2. Therefore, a degree of freedom of arrangement of the top-surface lines 20A and 20C is enhanced while the terminal portions near the bottom surface of the side-surface lines 11A and 11B are securely connected to the ground electrode 25.

Furthermore, since the side-surface lines 11A and 11B are configured as inclined straight lines, the side-surface lines 11A and 11B are longer than conventional side-surface lines which extend in a vertical direction, and therefore, the longer resonators attains low resonant frequencies. In other words, the same resonant frequency is attained by a small filter. Moreover, filter characteristics can be controlled by changing a degree of the inclination of the side-surface lines 11A and 11B. In addition, since the electrodes do not have angled portions and corners, a filter which has low conductor loss and which has an excellent Q value is realized.

Furthermore, the side-surface lines 12A and 12B are not required in terms of an electric configuration. Therefore, the side-surface lines 12A and 12B are arranged so as to be separated from the top-surface lines 20A to 20C so as not to affect the filter characteristics. However, in this embodiment, an electrode pattern on the back surface is formed so as to correspond to an electrode pattern on the front surface so that a manufacturing process is facilitated. Specifically, patterning of electrodes on the front surface 1A and the back surface 1B are performed without distinguishing between the front surface 1A and the back surface 1B using the same one of metal masking and screen masking.

Furthermore, the electrode pattern on the left surface including the side-surface line 13 having the side-surface lines 23, 33, and 43 and the electrode pattern on the right surface including the side-surface line 14 having the side-surface lines 24, 34, and 44 are formed so as to have the same shape as each other and symmetric about a point. Therefore, the patterns are formed without distinguishing between arrangement of the left surfaces 1C and arrangement of the right surface 1D and without distinguishing between arrangement of the top surface and arrangement of the bottom surface, and the same one of metal masking and screen masking is used.

According to the configuration of the strip line filter 1 described above, since, in each of the side-surface lines 11A and 11B, the terminal portion near the top surface and the terminal portion near the bottom surface are deviated from each other, even when the top-surface lines 20A to 20C are arranged in order to attain required filter characteristics, a gap width between the input/output electrodes 26A and 26B and the ground electrode 25 and sizes of the input/output electrodes 26A and 26B are ensured. Furthermore, by forming the electrode patterns on the surfaces while suppressing the number of steps for reaction control of the strip line filter 1, the strip line filter 1 can be manufactured with simple steps.

Next, a strip line filter 50 according to a second embodiment of the present invention will be described.

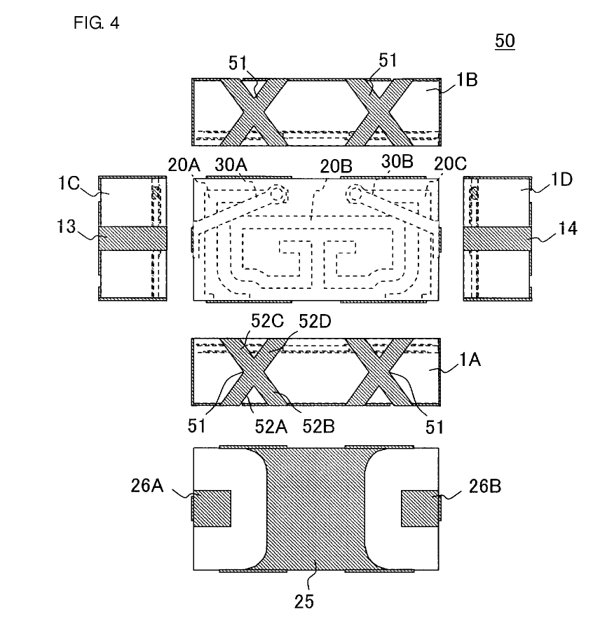

FIG. 4 is a development view illustrating the strip line filter 50 of this embodiment. The strip line filter 50 has electrode patterns on a front surface 1A and a back surface 1B which are different from those of the first embodiment. Note that components the same as those shown in the first embodiment are denoted by reference numerals the same as those used in the first embodiment and descriptions thereof are omitted.

On each of the front surface 1A and the back surface 1B of the strip line filter 50, side-surface electrodes 51 are arranged. Each of the side-surface electrodes 51 is formed in a substantially X-shape and has four leg portions 52A, 52B, 52C, and 52D.

In each of the side-surface electrodes 51, the leg portion 52A is arranged near a bottom surface of a dielectric substrate 2 and arranged on an outer side relative to the center of a corresponding one of the front surface 1A and the back surface 1B. The leg portion 52B is arranged near the bottom surface of the dielectric substrate 2 and arranged on an inner side relative to the center of a corresponding one of the front surface 1A and the back surface 1B. The leg portion 52C is arranged near a top surface of the dielectric substrate 2 and arranged on the outer side relative to the center of a corresponding one of the front surface 1A and the back surface 1B. The leg portion 52D is arranged near the top surface of the dielectric substrate 2 and arranged on the inner side relative to the center of a corresponding one of the front surface 1A and the back surface 1B. The leg portions 52A, 52B, 52C, and 52D are connected to one another at first terminals thereof.

The leg portion 52B is connected to a ground electrode 25. The leg portion 52C is connected to a top-surface line 20A. Therefore, the leg portions 52B and 52C constitute a side-surface line according to this embodiment of the present invention. On the other hand, the leg portion 52A is arranged separately from the ground electrode 25 and input/output electrodes 26A and 26B. The leg portion 52D is arranged separately from the top-surface line 20A and top-surface lines 20B and 20C. Therefore, the leg portions 52A and 52D constitute a sub-side-surface line according to this embodiment of the present invention.

The side-surface electrodes 51 are formed so as to be symmetric about a point in respective formation planes and have the same shapes. Accordingly, the patterns can be formed without distinguishing between the front surface 1A and the back surface 1B and without distinguishing between the top and bottom surfaces, and in addition, the same one of metal masking and screen masking can be used in both the pattering of the front surface 1A and the pattering of the back surface 1B.

A strip line filter 60 according to a third embodiment of the preset invention will now be described.

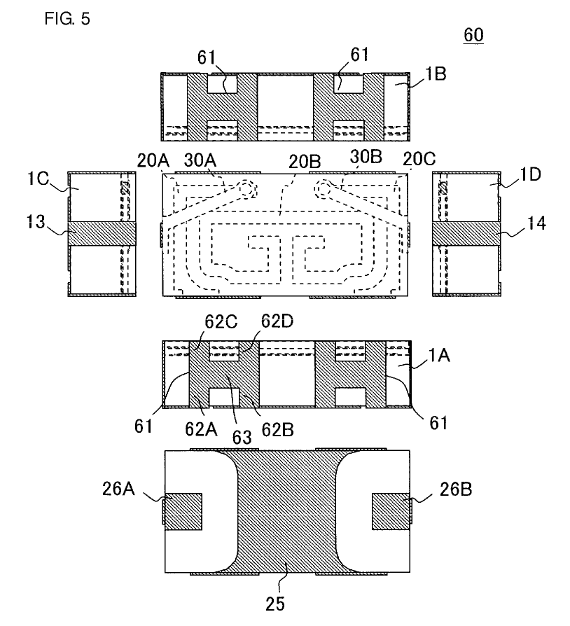

FIG. 5 is a development view illustrating the strip line filter 60 of this embodiment. The strip line filter 60 has electrode patterns on a front surface 1A and a back surface 1B which are different from those of the first and second embodiments. Note that components the same as those shown in the first embodiment are denoted by reference numerals the same as those used in the first embodiment and descriptions thereof are omitted.

On each of the front surface 1A and the back surface 1B of the strip line filter 60, side-surface electrodes 61 are arranged. Each of the side-surface electrodes 61 is formed in a substantially H-shape and has four leg portions 62A, 62B, 62C, and 62D and a connection portion 63. In each of the side-surface electrodes 61, the leg portion 62A is arranged near the bottom surface of a dielectric substrate 2 and arranged on an outer side relative to the center of a corresponding one of the front surface 1A and the back surface 1B. The leg portion 62B is arranged near the bottom surface of the dielectric substrate 2 and arranged on an inner side relative to the center of a corresponding one of the front surface 1A and the back surface 1B. The leg portion 62C is arranged near the top surface of the dielectric substrate 2 and arranged on the outer side relative to the center of a corresponding one of the front surface 1A and the back surface 1B. The leg portion 62D is arranged near the top surface of the dielectric substrate 2 and arranged on the inner side relative to the center of a corresponding one of the front surface 1A and the back surface 1B. The leg portions 62A, 62B, 62C, and 62D are connected to one another through the connection portion 63.

The leg portion 62B is connected to a ground electrode 25. The leg portion 62C is connected to a top-surface line 20A. Therefore, the leg portions 62B and 62C and the connection portion 63 constitute a side-surface line according to this embodiment of the present invention. On the other hand, the leg portion 62A is arranged separately from the ground electrode 25 and input/output electrodes 26A and 26B. The leg portion 62D is arranged separately from the top-surface line 20A and top-surface lines 20B and 20C. Therefore, the leg portions 62A and 62D and the connection portion 63 constitute a sub-side-surface line according to this embodiment of the present invention.

The side-surface electrodes 61 are formed so as to be symmetric about a point in respective formation planes and have the same shapes. Accordingly, the patterns can be formed without distinguishing between the front surface 1A and the back surface 1B and without distinguishing between the top and bottom surfaces, and in addition, the same one of metal masking and screen masking can be used in both the pattering of the front surface 1A a and the pattering of the back surface 1B.

Next, a strip line filter 70 according to a fourth embodiment of the preset invention will be described.

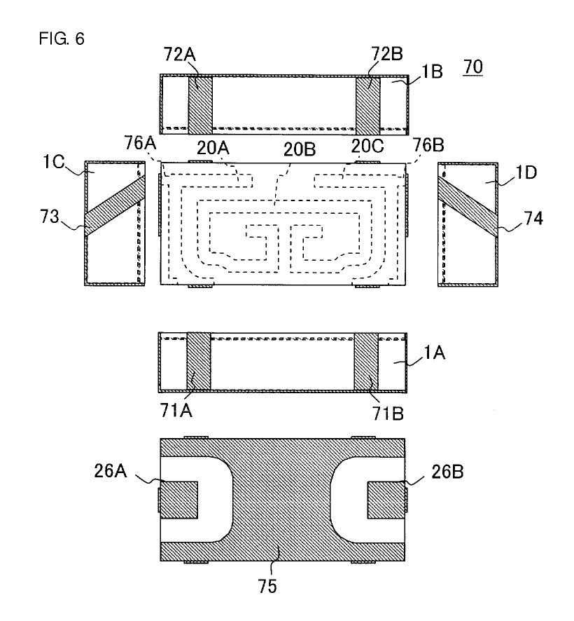

FIG. 6 is a development view illustrating the strip line filter 70 of this embodiment. The strip line filter 70 is different from those of the first to third embodiments in that electrode patterns of respective surfaces of the strip line filter 70 are different from those of the first to third embodiments and the first glass layer 3 and the external connection lines 30A and 30B are eliminated. Note that components the same as those shown in the first embodiment are denoted by reference numerals the same as those used in the first embodiment and descriptions thereof are omitted.

On a front surface 1A of the strip line filter 70, side-surface lines 71A and 71B are arranged so as to be perpendicular to top and bottom surfaces of a dielectric substrate 2, and on a back surface 1B, side-surface lines 72A and 72B are arranged so as to be perpendicular to the top and bottom surfaces of the dielectric substrate 2. On a left surface 1C and a right surface 1D, side-surface lines 73 and 74 inclined relative to a direction perpendicular to the top and bottom surfaces are arranged, respectively. On the bottom surface serving as an implementing surface, a ground electrode 75 and input/output electrodes 26A and 26B are arranged. On the top surface of the dielectric substrate 2, top-surface lines 20A to 20C and top-surface projecting lines 76A and 76B are arranged.

The side-surface line 73 is connected to the top-surface projecting line 76A and the input/output electrode 26A, and the top-surface projecting line 76A is directly connected to a side terminal of the top-surface line 20A near an open end of the upper-surface line 20A. Furthermore, the side-surface line 74 is connected to the top-surface projecting line 76B and the input/output electrode 26B, and the top-surface projecting line 76B is directly connected to a side terminal of the upper-surface line 20C near an open end of the top-surface line 20C.

Here, each of the side-surface lines 73 and 74 is straight line extending from one terminal portion thereof near the bottom surface located at the center of the substrate 2 to the other terminal portion near the top surface while inclining toward the back surface of the substrate 2. Therefore, the terminal portion of the side-surface line 73 near the bottom surface and the terminal portion of the side-surface line 73 near the top surface are deviated from each other, and the terminal portion of the side-surface line 74 near the bottom surface and the terminal portion of the side-surface line 74 near the top surface are deviated from each other. Accordingly, a degree of freedom of arrangement of the top-surface lines 20A and 20C and the top-surface projecting lines 76A and 76B is enhanced while the terminal portions of the side-surface lines 73 and 74 near the bottom surface are securely connected to the input/output electrodes 26A and 26B.

Next, a strip line filter 80 according to a fifth embodiment of the preset invention will be described.

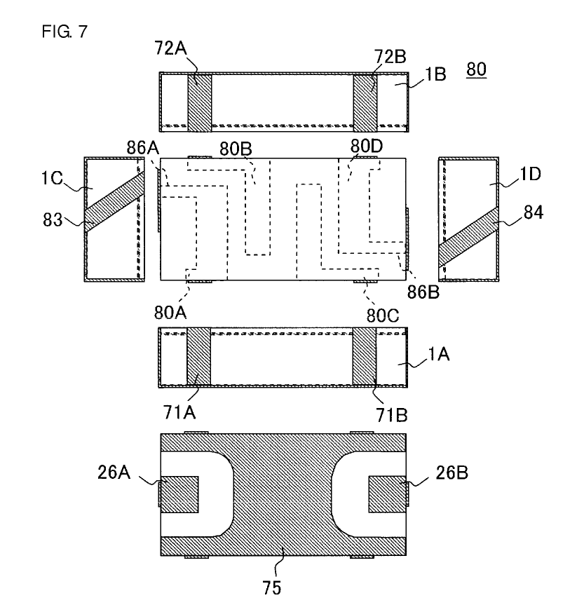

FIG. 7 is a development view illustrating the strip line filter 80 of this embodiment. The strip line filter 80 has electrode patterns on a right surface 1D and a top surface which are different from those of the fourth embodiment. Note that components the same as those shown in the fourth embodiment are denoted by reference numerals the same as those used in the fourth embodiment and descriptions thereof are omitted.

On the right surface 1D of the strip line filter 80, a side-surface line 84 is arranged. On a left surface 1C, a side-surface line 83 is arranged. On a top surface of a dielectric substrate 2, top-surface lines 80A to 80D and top-surface projecting lines 86A and 86B are arranged. The top-surface lines 80A to 80D each constitute ¼ wavelength resonators and are connected to one another in an interdigital manner. A side-surface line 71A is connected to the top-surface line 80A and a ground electrode 75. A side-surface line 71B is connected to the top-surface line 80C and the ground electrode 75. A side-surface line 72A is connected to the top-surface line 80B and the ground electrode 75. A side-surface line 72B is connected to the top-surface line 80D and the ground electrode 75. The side-surface line 83 is directly connected to the top-surface projecting line 86A, and the top-surface projecting line 86A is directly connected to an open end of the top-surface line 80A. The side-surface line 84 is directly connected to the top-surface projecting line 86B, and the top-surface projecting line 86B is directly connected to an open end of the top-surface line 80D.

Here, the side-surface line 84 is a straight line extending from one terminal portion thereof near the bottom surface located at the center of the substrate 2 to the other terminal portion near the top surface while inclining toward a front surface of the substrate 2. Therefore, the terminal portion of the side-surface line 84 near the bottom surface and the terminal portion of the side-surface line 84 near the top surface are deviated from each other in the right surface 1D. Accordingly, a degree of freedom of arrangement of the top-surface lines 80D and 86B is enhanced while the terminal portion of the side-surface line 84 near the bottom surface is securely connected to an input/output electrode 26B.

Furthermore, the side-surface line 83 has the same shape as the side-surface line 84. Therefore, patterning is performed without distinguishing between the left surface 1C and the right surface 1D, and in addition, the same one of metal masking and screen masking can be used for patterning of both the left surface 1C and the right surface 1D.

The arrangement position and the shapes of the top-surface resonant lines and the projecting lines depend on specification of a product, and any arrangement position and any shape may be employed as long as they comply with the specification of the product. The embodiments of the present invention may also be applicable to configurations other than the configuration described above, and applicable to various pattern forms of various filters. Furthermore, the filters of the foregoing embodiment may further include another configuration (a high-frequency circuit).

While preferred embodiments of the invention have been described above, it is to be understood that variations and modifications will be apparent to those skilled in the art without departing from the scope and spirit of the invention. The scope of the invention, therefore, is to be determined solely by the following claims.

What is claimed is:

1. A strip line filter, comprising:
a dielectric substrate having a top surface, a bottom surface opposing the top surface, and side surfaces connecting the top and bottom surfaces;
a ground electrode arranged on the bottom surface of the dielectric substrate;
input/output electrodes arranged on the bottom surface separately from the ground electrode;
top-surface lines arranged on the top surface of the dielectric substrate; and
at least one side-surface line arranged on at least one side surface of the side surfaces of the dielectric substrate, each of the at least one side-surface lines having a first terminal portion connected to one of the ground electrode and the input/output electrodes and a second terminal portion connected to one of the upper-surface lines, the first terminal portion and the second terminal portion being deviated from each other in a direction parallel to the top and bottom surfaces of the dielectric substrate.

2. The strip line filter according to claim 1, further comprising:
at least one sub-side-surface line arranged on the at least one side surface so as to intersect with the at least one side-surface line, each of the at least one sub-side-surface lines having a first terminal portion connected to the top surface and separated from the top-surface lines.

3. The strip line filter according to claim 2, wherein electrode patterns of the side surfaces having the side-surface lines and the sub-side-surface lines are symmetric about a center point thereof.

4. The strip line filter according to claim 2, wherein the at least one side-surface line and the at least one sub-side-surface line form a side-surface electrode having a substantial X-shape.

5. The strip line filter according to claim 2, wherein the at least one side-surface line and the at least one sub-side-surface line form a side-surface electrode having a substantial H-shape.

6. The strip line filter according to claim 1,
wherein the at least one side-surface lines are inclined relative to a direction perpendicular to the top and bottom surfaces of the dielectric substrate.

7. The strip line filter according to claim 1,
wherein the first terminal portion of the at least one side-surface lines are connected to the ground electrode.

8. The strip line filter according to claim 1,
wherein pairs of side surfaces, among the side surfaces, facing each other have the same electrode patterns.

9. The strip line filter according to claim 1, wherein a thickness of the at least one side-surface line is larger than a thickness of the top-surface lines.

10. The strip line filter according to claim 1, further comprising a first glass layer on the top surface of the dielectric substrate.

11. The strip line filter according to claim 10, further comprising a second glass layer on the first glass layer.

12. The strip line filter according to claim 11, wherein the second glass layer is a light shielding layer.

13. The strip line filter according to claim 1, wherein two side-surface lines are arranged on the at least one side surface of the dielectric substrate.

14. The strip line filter according to claim 13, further comprising:
a first sub-side-surface line arranged on the at least one side surface so as to intersect with a first of the two side-surface lines; and
a second sub-side-surface line arranged on the at least one side surface so as to intersect with a second of the two side-surface lines,
wherein each of the first and second sub-side-surface lines has a first terminal portion connected to the top surface and separated from the top-surface lines.

15. The strip line filter according to claim 14, wherein a first of the two side-surface lines and the first sub-side-surface line form a first side-surface electrode, and a second of the two side-surface lines and the second sub-side-surface line form a second side-surface electrode, each of the first and second side-surface electrode having a substantial X-shape.

16. The strip line filter according to claim 14, wherein a first of the two side-surface lines and the first sub-side-surface line form a first side-surface electrode, and a second of the two side-surface lines and the second sub-side-surface line form a second side-surface electrode, each of the first and second side-surface electrode having a substantial H-shape.

17. The strip line filter according to claim 13, wherein the two side-surface lines are arranged such that a first gap between respective first terminal portions of each of the two side-surface lines is smaller than a second gap between respective second terminal portions of each of the two side-surface lines.

18. The strip line filter according to claim 1, wherein the at least one side-surface line is an inclined straight line.

19. The strip line filter according to claim 18, herein the at least one side-surface line is inclined toward a back surface of the dielectric substrate.

20. The strip line filter according to claim 18, wherein the at least one side-surface line is inclined toward a front surface of the dielectric substrate.
